(19) United States
(12) Patent Application Publication
(10) Pub. No.: US 2014/0150886 A1
(43) Pub. Date: Jun. 5, 2014

(54) TWO-STAGE FLOCCULATION OF FLUID FINE TAILINGS

(71) Applicant: TOTAL E&P CANADA LTD., Calgary (CA)

(72) Inventors: Jianmin KAN, Calgary (CA); Alexandre GOLDSZAL, L'Etang-la-Ville (FR)

(73) Assignee: TOTAL E&P CANADA LTD., Calgary (CA)

(21) Appl. No.: 14/093,020

(22) Filed: Nov. 28, 2013

Related U.S. Application Data
(60) Provisional application No. 61/731,601, filed on Nov. 30, 2012.

(51) Int. Cl. F17D 1/08; B09B 1/00

(52) U.S. Cl. CPC F17D 1/088; B09B 1/00
USPC 137/13; 137/154

(57) ABSTRACT

A method for treating and disposal of fluid fine tailings utilizes two stages of thickening prior to disposal of the thickened tailings. The fluid fine tailings are adjusted to a sand-to-fines ratio of 0.5 to 1.3 using hydrocyclones or centrifuges in required. In a first stage of thickening a first flocculant is added to the fluid fine tailings which are fed to one or more conventional thickeners to produce a pumpable thickened tailings underflow having a solids content of between about 20 wt % to 40 wt %. The pumpable thickened tailings underflow is centrifugally pumped through a pipeline towards a disposal area. Adjacent the disposal area a second flocculant is added to the pumpable tailings underflow in a second stage of thickening to flocculate the tailings sufficient to produce a secondary thickened tailings underflow which when deposited has a solids content of about 50 wt % or higher at least one day after disposal. Alternatively, the second flocculant can be added prior to a paste thickener located adjacent the disposal area to further thicken the secondary thickened tailings underflow to a solids content of about 65 wt % for direct disposal at the disposal area.

### CROSS-REFERENCE TO RELATED APPLICATIONS

This application claims the benefit of U.S. Provisional Patent application Ser. No. 61/731,601, filed Nov. 30, 2012, the entirety of which is incorporated herein by reference.

### FIELD

Embodiments disclosed herein relate to the treatment of fluid fine tailings, such as produced as a result of oil sand processing, and more particularly, to the treatment of thickened tailings.

### BACKGROUND

Bitumen recovery from surface mined oil sand commences with the mining operation, in which large shovels sequentially excavate surface soils, overburden and the oil sand deposit. Mined oil sand material is typically hauled by trucks for further processing. Separate management of the soil and overburden is important for future reclamation activities. The oil sand itself may contain low grade bands of unprocessable interburden which is also handled separately.

Mined oil sand is trucked to an ore preparation plant (OPP) where mined oil sand is crushed and further comminuted with the addition of hot water to generate a slurry. If warranted, chemicals to enhance bitumen recovery are added. The slurry is then pipelined to an extraction plant for processing, typically through a series of settling and flotation vessels where bitumen-rich froth is extracted from the bulk of the water and the solids in the slurry. The water, coarse solids and fine solids discharged from the extraction plant form large volumes of liquid tailings, typically comprising the fine solids having a diameter less than about 44 microns, and solid tailings, typically comprising the coarse solids having a diameter greater than about 44 microns. The bitumen-rich froth is further processed in a froth treatment plant to produce a final bitumen product and a smaller, froth treatment tailings stream comprising primarily fine solids and water. Conventional handling and disposal of the accumulations of fluid fine tailings from extraction and froth treatment presents great challenges with respect to reclamation.

As a consequence, the Energy Resources Conservation Board (ERCB) of Alberta, Canada, issued Directive 074, “Tailings Performance Criteria and Requirements for Oil Sands Mining Schemes” in 2009. The directive establishes stringent criteria for the reduction of fluid tailings and the formation of trafficable deposits, and stipulates a comprehensive protocol for reporting the performance of fine tailings deposits. In summary, Directive 074 requires that 50% of the fines in the processed oil sand ore feed be captured immediately in designated disposal areas (DDAs). Further, the fines deposited in the DDAs must achieve a minimum undrained shear strength of 5 kilopascals (kPa) in the materials deposited in the previous year and be ready for reclamation within 5 years after active deposition has ceased by ensuring that a trafficable surface layer of the deposit has a minimum undrained shear strength of 10 kPa.

Applicant is aware that others have utilized flocculants to attempt to improve the rheology and dewatering capability of mature fine tailings (MFT) such as found in tailings ponds. MFT differ significantly from thickened tailings (TT) in many ways, one of which is that the sand-to-fine ratio (SFR) of MFT is significantly lower, being less than about 0.1.

Clearly there is interest in the industry to develop more efficient and effective means of disposal of fine tailings and particularly with respect to the objectives of reclamation within established timelines.

### SUMMARY

A method and system for treatment and disposal of fluid fine tailings comprises two stages of thickening. The first stage of thickening using an amount of flocculant added prior to a conventional thickener to result in a pumpable thickened tailings underflow which can be transported towards the disposal site using conventional pumping equipment. In the second stage of thickening, at a point adjacent the disposal area, an amount of a second flocculant is added which results in a thickened tailings which when deposited is suitable for meeting or exceeding the Directive 074 requirements.

In a first broad aspect, a method for treating and disposing of fluid fine tailings having a sand-to-fine solids ratio (SFR) between about 0.5 to about 1.3 comprises, in a first stage of thickening, adding an amount of a first flocculant to the fluid fine tailings for forming a thickener feedstream. The thickener feedstream is fed to at least one thickener for producing a pumpable, first thickened tailings underflow. The first thickened tailings underflow is pumped to flow in a pipeline toward at least one disposal area. In a second stage of thickening, an amount of a second flocculant is added to the first thickened tailings underflow flowing through the pipeline for producing a secondary thickened tailings underflow for disposal at the at least one disposal area.

The pumpable thickened tailings underflow has a solids content from about 20 wt % to about 40 wt % and a yield stress of less than 20 Pa, suitable for pumping using conventional centrifugal pumps. Following the addition of the second flocculant and transport to the disposal area, the secondary thickened tailings underflow achieves a solids content of at least about 50 wt % at the disposal area at least one day after depositing.

Alternatively, a paste thickener, positioned adjacent the disposal area, receives the secondary thickened tailings underflow for thickening to a solids contenct of about 65 wt % for direct depositing at the disposal area.

In another broad aspect, a system for treatment and disposal of fluid fine tailings having a sand-to-fine solids ratio (SFR) between about 0.5 to about 1.3 comprises: in a first stage of thickening, at least one thickener for receiving flocculated fluid fine tailings, an amount of a first flocculant having been added to the fluid fine tailings for producing a pumpable first thickened tailings underflow. A pipeline connects between the at least one thickener and at least one disposal area. One or more pumps pump the pumpable first thickened tailings underflow to flow through the pipeline from the at least one thickener to the at least one disposal site. In a second stage of thickening, an amount of a second flocculant is added to the pumpable first thickened tailings underflow at a point of addition in the pipeline adjacent the at least one disposal site for producing a secondary thickened tailings underflow. The amount of the second flocculant causes the secondary thickened tailings underflow, when deposited at the at least one disposal area, to dewater and further thicken to a solids content therein of at least about 50 wt % or greater after about one day following depositing.

In an embodiment, the system further comprises a paste thickener positioned adjacent the disposal area for receiving the secondary thickened tailings for further thickening to a solids content of about 65 wt % for depositing at the disposal site.

### BRIEF DESCRIPTION OF THE DRAWINGS

FIG. 1A is a diagrammatic representation of a proposed thickener system based on conventional knowledge in the art and having an embodiment of a shearing system incorporated therein;

FIG. 1B is a diagrammatic representation of an alternate shear thinning system for the proposed system of FIG. 1A;

FIG. 2 is a graph illustrating the relationship between solids content and yield stress;

FIG. 3A is a diagrammatic representation of an embodiment utilizing conventional thickeners, pumps and two-stage flocculation of fluid fine tailings;

FIG. 3B is a diagrammatic representation according to FIG. 3A, a paste thickener having been added at or near the dedicated disposal area for receiving the thickened tailings after the addition of the second stage flocculant; and

FIG. 4 is a table of results from pilot testing of embodiments taught herein.

### DETAILED DESCRIPTION OF THE PREFERRED EMBODIMENTS

Generally, thickeners are known for use in the treatment of fluid fine tailings streams, such as fluid fine tailings resulting from froth flotation. Use of thickeners however presents challenges with respect to reliable transport of the underflow therefrom depending upon the solids content therein.

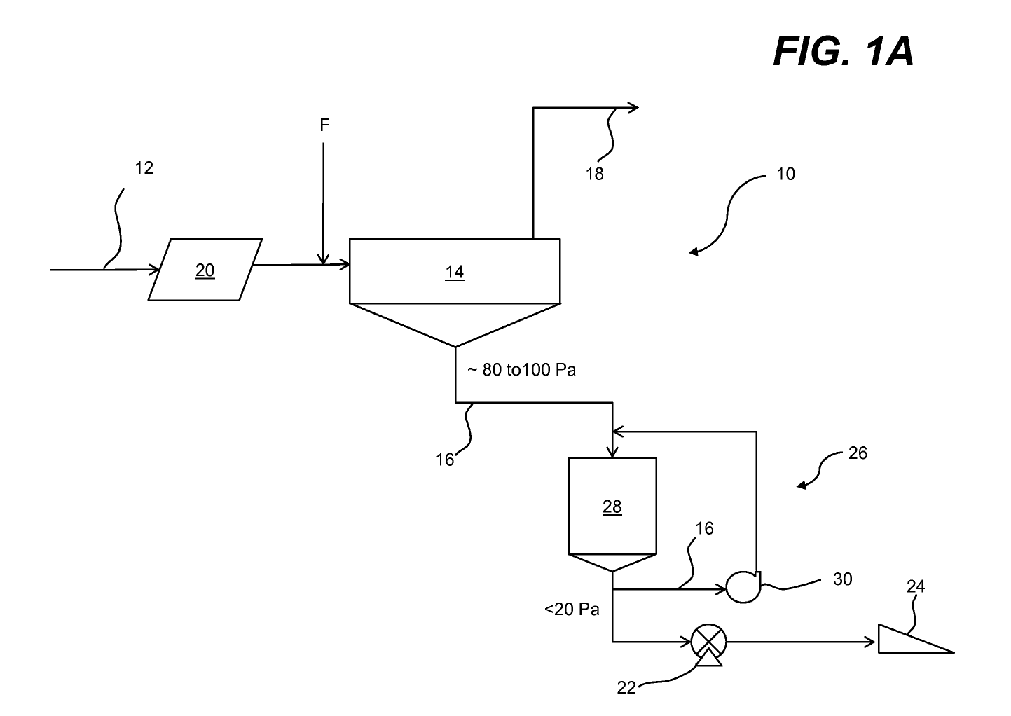

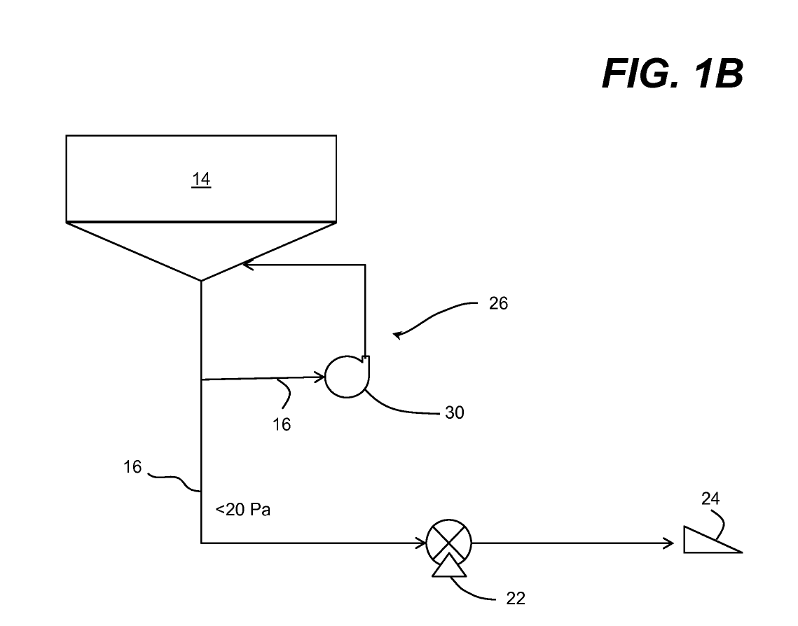

Applicant's early considerations for meeting Directive 074 initially contemplated utilizing high rate thickeners, shear thinning, specialized pumping equipment and upstream screening apparatus. Applicant has provided an example of such a proposed system in FIG. 1A, and described below, for illustrating the need for alternate solutions. However, such embodiments would result in relatively high cost systems which may also be prone to operational problems.

Having reference to FIG. 1A, a system 10 for thickening fluid fine tailings was proposed based upon conventional knowledge in the industry. The fluid fine tailings 12 are primarily flotation underflow having a solids content of less than about 10 wt % to 15 wt %. The fluid fine tailings 12 were to be treated or dosed with a flocculant F and then introduced to at least one high-rate thickener 14. In order to meet the Directive 074 objective for an underflow 16 from the thickener 14, it was proposed to use high rate thickeners, such as 70 m diameter thickeners having conical bottom sections which are deeper than in conventional thickeners, to receive and thicken the fluid fine tailings 12 to an underflow 16 comprising about 50 wt % solids. Two such thickeners 14 could be used to produce about 3900 t/h (2735 m³/h) of the 50 wt % solids underflow. Water 18 released as an overflow from the thickeners 14 would generally be recycled for use in upstream processing of the oil sands.

The fluid fine tailings 12 were to be first screened using upstream screening apparatus 20, to remove particles which were greater than about 6 mm so as to minimize damage to a plurality of downstream, positive displacement pumps 22, such as diaphragm pumps, operated in parallel, which were to be utilized to pump the thickener underflow 16 to at least one dedicated disposal area (DDA) 24. In many cases, the at least one DDA 24 could be a significant distance, for example about 7 to 10 kilometers, from the site of the thickener 14.

Analysis suggested the screened and thickened tailings underflow 16, having the about 50 wt % solids content, would typically have a yield stress of about 80-100 Pa and would be substantially unpumpable for at least the long distance to the at least one DDA 24. The underflow 16 therefore would have to be subjected to a shearing system, such as a shear thinning loop 26 having a tank 28 and at least one shear pump 30, to reduce the yield stress to less than about 20 Pa to permit pumping of the underflow to the at least one DDA 24.

As shown in FIG. 1B, in an alternate shear thinning loop 26, the underflow 16 would be shear thinned and returned to the bottom of the thickener 14 for storage therein. While the alternate shear system is simplified compared to the shear system shown in FIG. 1A, the addition of newly formed underflow 16 added into the stored sheared material would make it more difficult to control the yield stress lower than about 20 Pa, as it would be difficult to control the ratio of sheared to unsheared material therein.

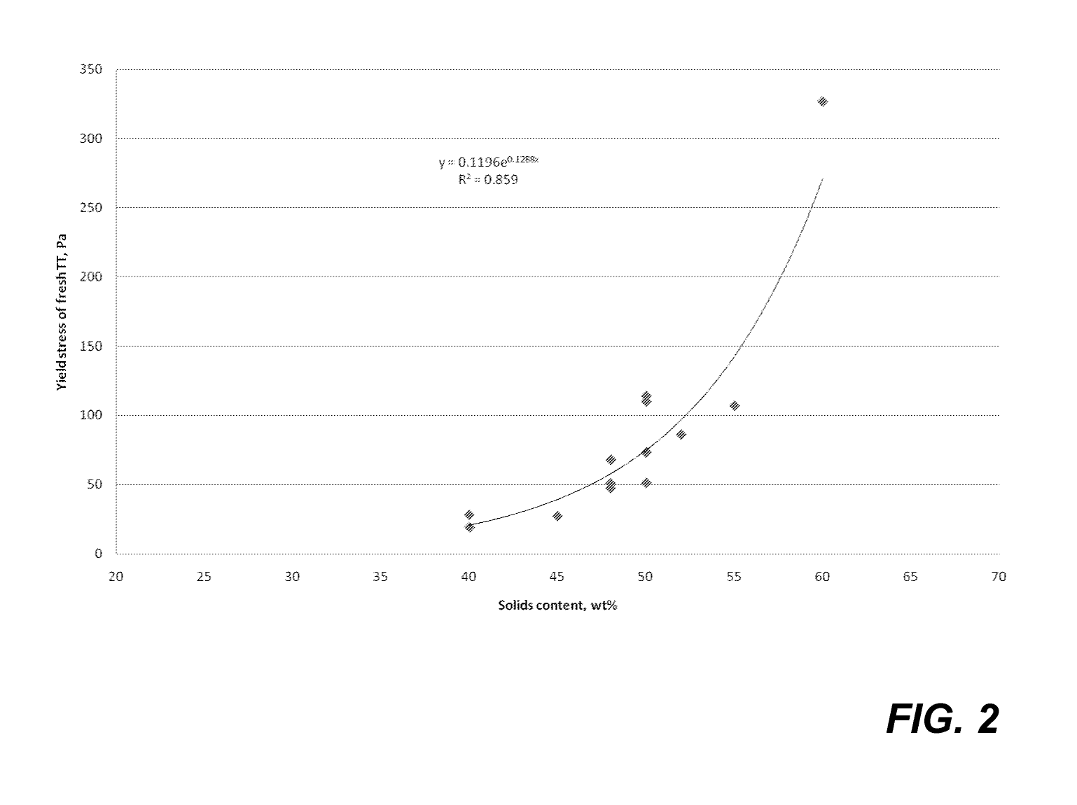

As one of skill in the art will appreciate, having reference to FIG. 2, diaphragm pumping systems may be significantly impacted by slight increases in the solids content of thickened tailings underflow which significantly alters the yield stress of the fluid being pumped. Should a shutdown occur during the pumping operation, some dewatering of the thickened tailings could occur in the pipelines and there may be a rebuild of the yield stress causing significant problems with restarting of the pumping operation.

Any increases in flocculant dosage to the thickener feed, over and above the design dosage, may result in an underflow having a significantly increased yield stress.

With the requirement for specialized thickeners, and a plurality of diaphragm pumps and upstream screening apparatus and where the at least one DDA is located several kilometers from the thickener, the capital expenditure of such a proposed system is found to be high and the overall footprint is large.

### Embodiments of a Two-Stage Flocculation System

Embodiments of an alternate fluid fine tailings thickening system, disclosed herein, overcome the deficiencies of the prior art and Applicant's own earlier proposed system. Such embodiments are capable of producing a thickened tailings underflow for deposition in at least one dedicated disposal area (DDA) suitable for meeting the Directive 074 guidelines without the need for high rate thickeners, shear thinning, specialized pumping equipment and upstream screening apparatus.

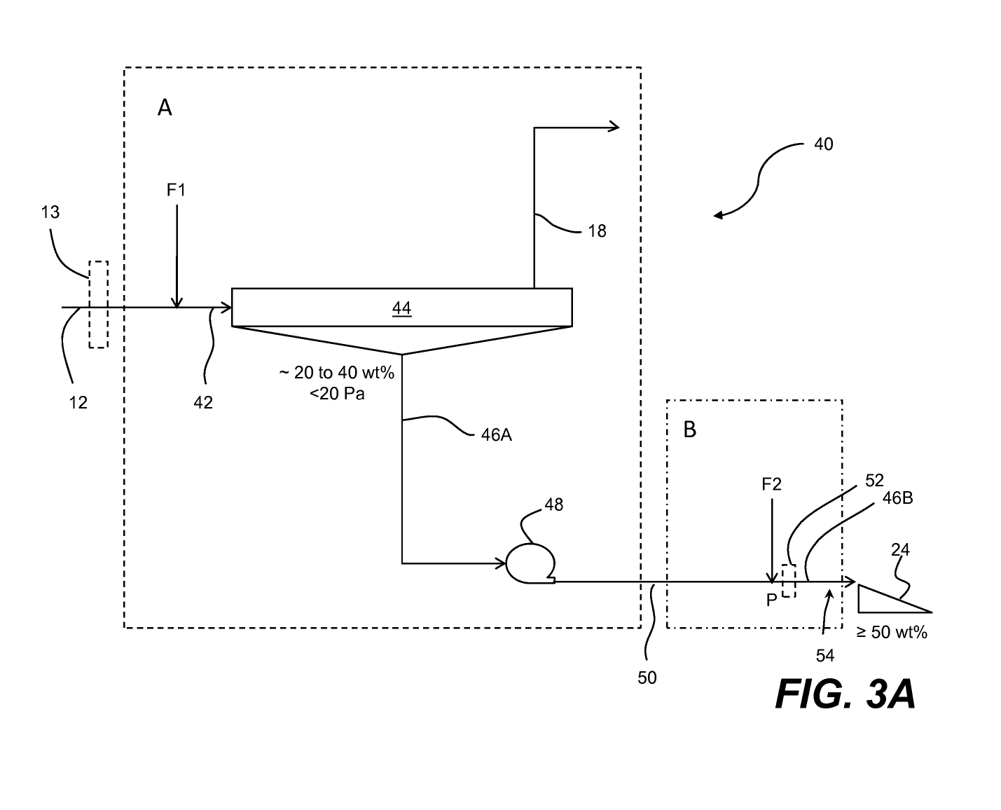

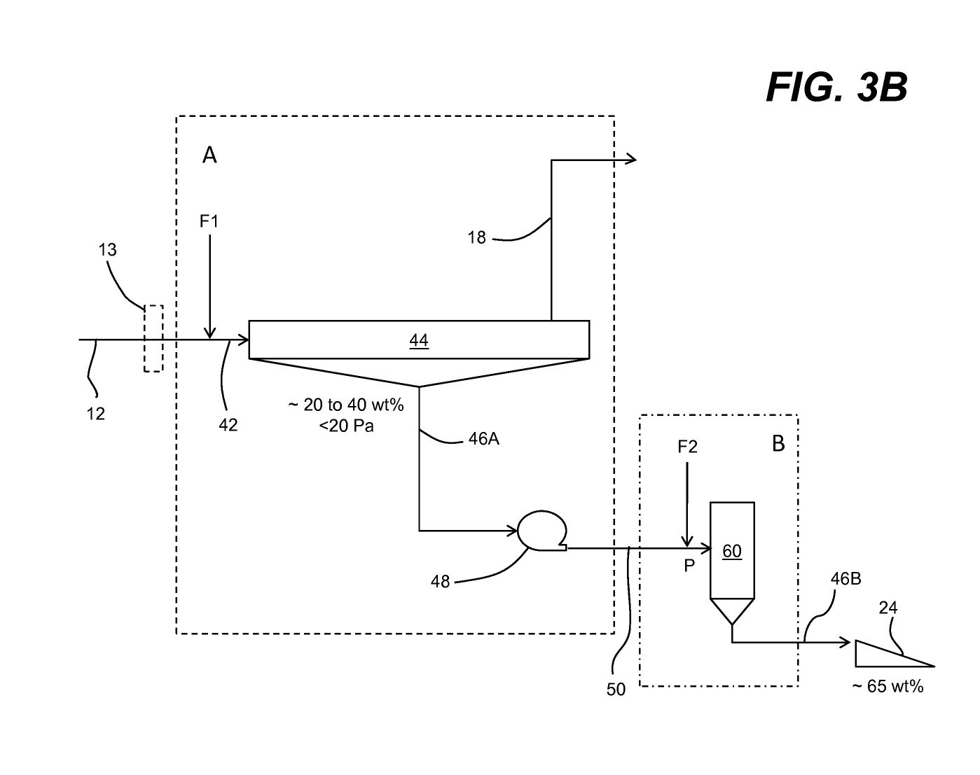

Having reference to FIG. 3A, in an embodiment, an extraction tailings stream 11, such as flotation underflow, may be first adjusted or process-conditioned to produce the fluid fine tailings stream 12 having a sand-to-fine ratio (SFR) between about 0.5 to about 1.3 and more particularly to about 0.8. As one of skill will appreciate, the process-conditioning 13 can be accomplished using centrifugal separation or classification, such as with hydrocyclones or centrifuges for removal of coarse materials and the like to achieve the desired SFR range. Alternatively, the process-conditioning can be accomplished by proportionally mixing a coarse tailings stream with the fine extraction tailings stream 11 to increase the amount of coarse tailings therein to achieve the desired SFR. The fluid fine tailings 12 typically have a solids content of about 10 wt % to about 15 wt %. Further, as one of skill can appreciate, the fluid fine tailings 12 may include primary, secondary and/or tertiary flotation tailings and combinations thereof. Further, at least a portion of the fluid fine tailings 12 may include mature fine tailings (MFT), such as MFT recycled from tailings ponds. Typically, the addition of MFT would not exceed about 20 wt % dry solids of MFT/dry solids of the fluid fine tailings thickener feed.

In a first stage of thickening A, in an embodiment of the two-stage flocculation system 40, an amount of a first flocculant F₁ is added to process-conditioned conditioned fluid fine tailings 12 for forming a thickener feed 42, being the flocculated fluid fine tailings 12. The first flocculant F₁ controls the rheology of the thickener feed 42 for delivery to one or more conventional thickeners 44 for dewatering therein. The first thickened tailings underflow 46A from the one or more conventional thickeners 44 is controlled to a solids content of about 20 wt % to about 40 wt % and a yield strength of less than about 20 Pa (see FIG. 2). As such, the first thickened tailings underflow 46A is pumpable to the at least one DDA 24 using conventional centrifugal pumps 48 and does not require screening of the thickener feed 42 nor shear thinning of the first thickened tailings underflow 46A. The pumpable, first thickened tailings underflow 46A is pumped by the centrifugal pumps 48 to flow in a pipeline 50 between the at least one thickener 44 and the at least one DDA 24.

In order to achieve appropriate dewatering and consolidation of the tailings at the at least one DDA 24, such as to achieve the Directive 074 objectives, a second stage of thickening B is performed. An amount of a second flocculant F₂ is added to the first thickened tailings underflow 46A so as to increase the solids content of the first thickened tailings underflow 46A producing a secondary thickened tailings underflow 46B wherein the solids content is increased from the about 20 wt % to about 40 wt % solids content to a solids content of about 50 wt % or greater, about 1 day after deposition of the secondary thickened tailings underflow 46B at the at least one DDA 24.

The second flocculant F₂ is added to the first thickened tailings underflow 46A flowing in the pipeline 50. In an embodiment, the second flocculant F₂ is added to the first thickened tailings underflow 46A at a point P adjacent the at least one DDA 24, typically at about 100 meters, and possibly about a few hundred meters, away from the at least one DDA 24. A mixer 52 can be installed in a terminal portion 54 of the pipeline 50 following the point of addition P of the second flocculant F₂ to ensure thorough mixing of the second flocculant F₂ with the flowing first thickened tailings underflow 46A for forming the secondary thickened tailings underflow 46B.

In an embodiment, a length and a diameter of the terminal section 54 of pipeline 50 are adjusted to control residence time and turbulence of the secondary thickened tailings underflow 46B therein so as to effectively flocculate and achieve the desired rheology.

In an embodiment, the first and second flocculants F₁,F₂ added in the first and second stages of thickening A,B are conventional flocculants including blends of flocculants and can be anionic or cationic flocculants. The first flocculant F₁ added in the first stage of thickening can be the same flocculant as the second flocculant added in the second stage of thickening. Alternatively, the first flocculant can be a different flocculant than the second flocculant. As one of skill in the art will understand, adjustment of the pH may or may not be required, depending upon at least the type of flocculants selected.

In embodiments, the flocculants are charged polyacrylamides. One such charged polyacrylamide is a high molecular weight polyacrylamide-sodium polyacrylate co-polymer with a charge density between 20% and 60%. The polyacrymide-sodium polyacrylate co-polymer may be linear or branched.

Flocculants can be a blend of flocculants, typically a blend of low molecular weight flocculants and high molecular weight flocculants. In an embodiment, the flocculants have a molecular weight of between about 5 million and about 30 million.

In one embodiment, the first and second flocculants F₁,F₂ are the same anionic flocculant, such as SNF 3338, available from SNF Energy Services Inc. of Edmonton, Alberta, Canada or can be a mixture of anionic flocculants SNF3338 and AF309 for both the first and second flocculants F₁,F₂. The flocculant AF309 is also available from SNF Energy Services Inc. Applicant believes that conventional wisdom would dictate that the sum of the amounts of the first second flocculants F₁,F₂ would be significantly greater than that required if one were to do a single stage flocculation to achieve the 50 wt % or greater solids content. Further, it was thought that shear thinning caused by the pumping of the first thickened tailings underflow 46A through the centrifugal pumps 48 would substantially destroy the floc formed in the first stage of thickening A and therefore dictate a very high dosage of the second flocculant F₂ in the second stage of thickening B to rebuild the floc.

Applicant has determined that this is not the case and the overall amount of the flocculant F₁,F₂, and thus the overall cost, is similar to that required for a single stage flocculation, as is understood by one of skill in the art.

The amount of the first flocculant F₁ generally depends upon the clay content of the fluid fine tailings feed stream 12 and the desired solids content of the first stage thickener underflow 46A. If the clay content is higher, additional first flocculant F₁ is required. Similarly, the higher the solids content is designed to be in the first stage thickener underflow 46A, the more of the second flocculant F₂ is required for forming the second stage, secondary underflow 46B. By way of example, in embodiments, where the SFR of the initial feed is about 0.8, Applicant believes that dosage rates of about 100 g/t to 150 g/t for the first flocculant F₁ and about 50 g/t to 100 g/t for the second flocculant F₂ may be sufficient to achieve the 50 wt % solids content or greater in the secondary thickened tailings underflow 46B for deposition at the at least one DDA 24.

In an alternate embodiment, as shown in FIG. 3B, the second stage of thickening B further comprises a second thickener 60, such as a paste thickener. The second flocculant F₂ is added to the first thickened tailings underflow 46A flowing in the pipeline 50 as previously described. The flocculated secondary thickened tailings underflow 46B acts as a feed stream for the paste thickener 60. In this embodiment, the paste thickener 60 is located at or near the at least one DDA 24 and the final secondary thickened tailings underflow 46B has a solids content of about 65 wt %, which is more than suitable for direct deposition at the at least one DDA 24.

### Testing

Pilot studies were performed using two separate batches of fluid fine tailings feed 12. The solids content of the first thickened tailings underflow 46A as feed to the second stage, mixing and methods of handling the second stage of thickening B, whether depositing the secondary tailings underflow 46B by beaching at the DDA 24 or by using a paste thickener 60 prior to direct depositing of the secondary tailings underflow 46B, were altered between tests.

A series of seven tests were performed using the first and second stage of thickening A,B followed by deposition on a flume to simulate beach disposal at a DDA 24. A single test was performed using a paste thickener 60 following the addition of the second flocculant F₂.

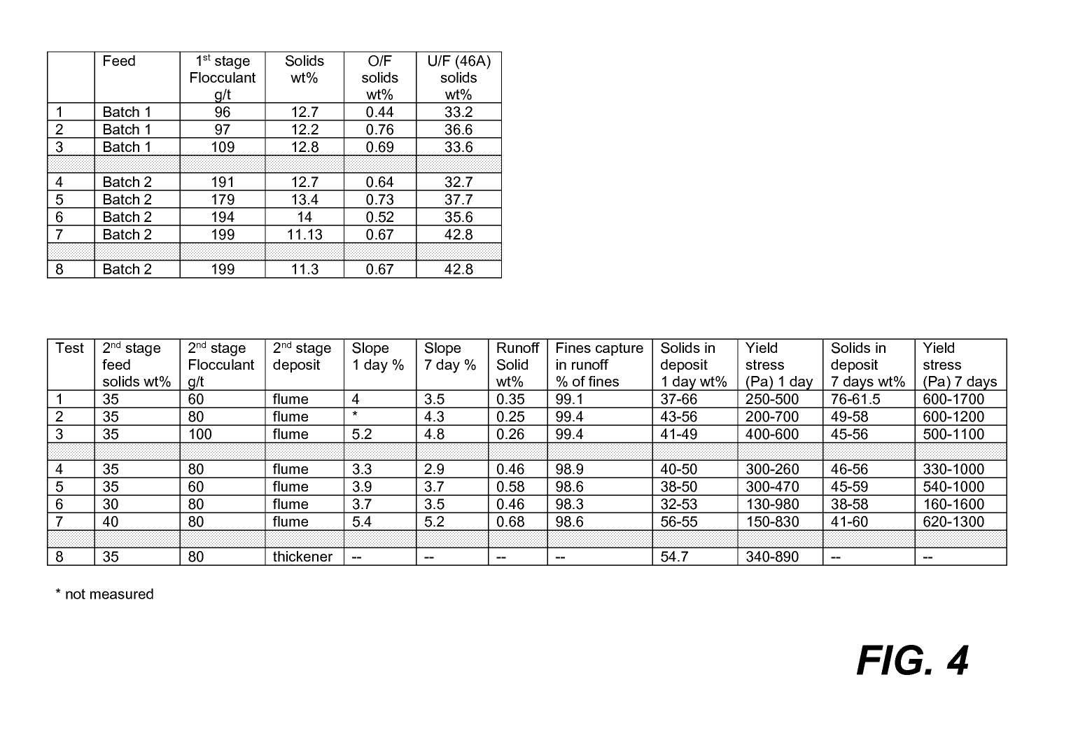

The results, tabulated in FIG. 4, illustrate that there were no issues with second stage of thickening, the amount of flocculant not exceeding that proposed by Applicant. Applicant believes therefore that large amounts of flocculant are not required to rebuild floc as a result of any shearing which may occur as a result of pumping, contrary to that currently thought to be the case by those of skill in the art. The fines recovery was high and the amount of solids in run-off water was low. The yield strengths measured at one day and seven days after deposition are sufficient to meet or exceed the Directive 074 objectives.

The embodiments in which an exclusive property or privilege is claimed are defined as follows:

1. A method for treating and disposing of fluid fine tailings having a sand-to-fine solids ratio (SFR) between about 0.5 to about 1.3 comprising:
in a first stage of thickening,
adding an amount of a first flocculant to the fluid fine tailings for forming a thickener feedstream; and
feeding the thickener feedstream to at least one thickener for producing a pumpable, first thickened tailings underflow; and
pumping the first thickened tailings underflow to flow in a pipeline toward at least one disposal area; and
in a second stage of thickening,
adding an amount of a second flocculant to the first thickened tailings underflow flowing through the pipeline for producing a secondary thickened tailings underflow for disposal at the at least one disposal area.

2. The method of claim 1 further comprising:
depositing the secondary thickened tailings underflow at the at least one disposal area, wherein, when deposited, dewatering and thickening occurs to a solids content therein of at least about 50 wt % or greater after about one day following the depositing.

3. The method of claim 1 wherein the pumpable first thickened tailings underflow has a solids content of between about 20 wt % to about 40 wt % and a yield stress of less than about 20 Pa.

4. The method of claim 1 further comprising:
adding the amount of the second flocculant to the pumpable, first thickened tailings underflow flowing through the pipeline at a location adjacent the disposal area.

5. The method of claim 1 further comprising:
adding the amount of the second flocculant to the pumpable first thickened tailings underflow flowing through the pipeline at an addition point about one hundred meters from the disposal area.

6. The method of claim 1 further comprising:
mixing the second flocculant with the pumpable first thickened tailings underflow flowing in the pipeline using a mixer located in a terminal portion of the pipeline between the addition point and the disposal area.

7. The method of claim 6 further comprising:
adjusting a length and a diameter of the terminal portion of the pipeline to control residence time and turbulence for mixing and effectively flocculating the pumpable first thickened tailings underflow therein for forming the secondary thickened tailings underflow.

8. The method of claim 1 wherein the first and second flocculants are anionic flocculants or cationic flocculants.

9. The method of claim 1 wherein the first and second flocculants are the same flocculant.

10. The method of claim 1 wherein the first and second flocculants are different flocculants.

11. The method of claim 1 wherein when the SFR is about 0.8, the amount of the first flocculant is from about 100 g/t to about 150 g/t.

12. The method of claim 1 wherein when the SFR is about 0.8, the amount of the first flocculant is from about 100 g/t to about 150 g/t.

13. The method of claim 1 wherein when the SFR is about 0.8, the amount of the second flocculant is from about 50 g/t to about 100 g/t.

14. The method of claim 1 further comprises:
receiving the pumpable first thickened tailings underflow, after the addition of the second flocculant, at a paste thickener located at or adjacent the disposal area; and
thickening the first thickened tailings underflow in the paste thickener for producing the secondary thickened tailings underflow therein having a solids content of at least about 65 wt % for disposal at the disposal area.

15. The method of claim 1, prior to the adding of the first flocculant, further comprising:
adjusting a sand-to-fine solids ratio (SFR) of extraction tailings to between about 0.5 to about 1.3.

16. The method of claim 15 wherein the adjusting the SFR comprises:
treating the extraction tailings using centrifugal classification for removal of coarse tailings therefrom.

17. The method of claim 15 wherein the adjusting the SFR comprises:
proportionally mixing the extraction tailings with coarse tailings.

18. The method of claim 1 further comprising:
pumping the pumpable thickener underflow using a centrifugal pump.

19. A system for treatment and disposal of fluid fine tailings having a sand-to-fine solids ratio (SFR) between about 0.5 to about 1.3 comprising:
in a first stage of thickening,
at least one thickener for receiving flocculated fluid fine tailings, an amount of a first flocculant having been added to the fluid fine tailings for producing a pumpable first thickened tailings underflow;
a pipeline connected between the at least one thickener and at least one disposal area
one or more pumps for pumping the pumpable pumpable first thickened tailings underflow to flow through the pipeline from the at least one thickener to the at least one disposal site; and
in a second stage of thickening,
a point of addition in the pipeline adjacent the at least one disposal site for adding an amount of a second flocculant to the pumpable first thickened tailings underflow flowing through the pipeline to produce a secondary thickened tailings underflow, wherein
the amount of the second flocculant causes the secondary thickened tailings underflow, when deposited at the at least one disposal area, to dewater and further thicken to a solids content therein of at least about 50 wt % or greater after about one day following depositing.

20. The system of claim 19 wherein the pumpable, first thickened tailings underflow from the at least one thickener has a solids content of about 20 wt % to about 40 wt %.

21. The system of claim 19 further comprising:
a paste thickener positioned adjacent the disposal area for receiving the secondary thickened tailings underflow for thickening therein to a solids content of at least about 65 wt % for disposal at the disposal area.

22. The system of claim 19 wherein, when the SFR is about 0.8, the amount of the first flocculant is about 100 g/t to about 150 g/t and the amount of the second flocculant is about 50 g/t to about 100 g/t.

23. The system of claim 19 further comprising a mixer positioned in the pipeline following the point of addition of the second flocculant.

24. The system of claim 19 further comprising apparatus for centrifugal classification of extraction tailings for adjusting a sand-to-fine solids ratio (SFR) to between about 0.5 to about 1.3.
